(19) United States
(12) Patent Application Publication
(10) Pub. No.: US 2020/0096843 A1
(43) Pub. Date: Mar. 26, 2020

(54) INTERCHANGEABLE BOARD MOUNT SYSTEM

(71) Applicant: Andrew Linney, Carlsbad, CA (US)

(72) Inventor: Andrew Linney, Carlsbad, CA (US)

(21) Appl. No.: 16/579,801

(22) Filed: Sep. 23, 2019

Related U.S. Application Data
(60) Provisional application No. 62/735,015, filed on Sep. 21, 2018.

(51) Int. Cl. G03B 17/56; A63C 17/00; B63B 35/85

(52) U.S. Cl. CPC G03B 17/561; B63B 35/79; B63B 35/85; A63C 17/0006

(57) ABSTRACT

A board mount system is provided for securely mounting an action sports accessory with a sports board by securing a base mount with the sports board, the base mount including an interlocking opening for rotatably attaching interchangeable adapters that are attached to or incorporated with the action sports accessory, such as a camera, gimbal, hook, shelf, handle or secure cover. The base mount may be secured physically or magnetically to the board via screws or magnets positioned at peripheral corners of the base mount within cylindrical housings which interface directly with a surface of the board, while a mount surface of the base mount is connected with a top portion of the cylindrical housings so that the mount surface is raised above the surface of the board to allow the adapters to securely fit into the interlocking opening or in a space between the mount surface and the board.

### BACKGROUND

### Field of the Invention

Provided herein is a mount system for action sports equipment, and more particularly to a board mount with interchangeable adapters for securely mounting a variety of action sports accessories with a sports board such as a skateboard, surfboard or other action sport item.

### Related Art

In the action sports industry, a significant focus is placed not on simply participating and performing in a particular sport, but in capturing photo and video footage of the activity. An entire new segment of photo and video devices has been created to allow participants in action sports and other outdoor activities to capture their activities, where traditional cameras, video recording devices and smartphones are not able to.

A significant drawback of capturing footage of an action sport or outdoor activity is the need to perform the activity without holding or manipulating the photo or video-recording device so as not to impede a user's ability to perform the activity. Thus, many companies have designed various clips, straps and mounts to help a user secure a camera to their body or their sports equipment and avoid having to hold the camera.

However, many of the clips do not securely attach a camera to the equipment, while many of the straps require that the camera be secured to the user and limit the perspective of the camera to whatever the user is viewing. To provide a better perspective, many types of mounts can be secured to a surface of the sports equipment, although they typically require a permanent adhesive mount which often fails, or a mechanically fixed mount which may be obtrusive to the user and which are difficult to properly attach and detach with a camera.

Therefore, it is desirable to develop mounts for action sports equipment which improve the ability to securely attach and remove a camera or other accessory.

### SUMMARY

Embodiments described herein provide for a board mount system with a base mount secured with a board and an interlocking opening disposed on the base mount for removably attaching interchangeable adapters that permit the connections of multiple types of accessories and tools, such as a camera, gimbal, storage hook or mount cover. The base mount may be secured physically or magnetically to the board via screws or magnets positioned at four corners of the base mount within cylindrical housings which interface directly with a surface of the board, while a mount surface of the base mount is connected with a top portion of the cylindrical housings so that the mount surface is raised above the surface of the board to allow the adapters to securely fit into the interlocking opening. The adapters can attach any type of accessory or tool with the interlocking board mount via a twist locking mechanism or tab locking mechanism which do not require the use of tools or which include the tool as part of the adapter itself.

In one embodiment, a board mount system for attaching an action sports accessory to a sport board comprises: a base mount comprising peripheral housings for attaching the base mount to a board deck of the sport board, and an interlocking opening; and an interchangeable adapter with an interlocking connector for rotatably attaching with the interlocking opening of the base mount, and a connector for securing an action sports accessory.

In another embodiment, a method for mounting an action sports accessory to a sport board, comprising the steps of: attaching a base mount with a board deck of the sport board; rotatably attaching an adapter with an interlocking opening on the base mount; and attaching an accessory with the adapter.

In a further embodiment, a board mount for attaching an action sports accessory thereto, comprises: a base mount comprising peripheral housings for attaching the base mount to a board deck of a sport board; an interlocking opening disposed within the base mount for retaining a first accessory; and an insert opening disposed between two of the peripheral housings on an underside of the base mount for retaining a second accessory.

Other features and advantages of the present invention will become more readily apparent to those of ordinary skill in the art after reviewing the following detailed description and accompanying drawings.

### BRIEF DESCRIPTION OF THE DRAWINGS

The structure and operation of the present invention will be understood from a review of the following detailed description and the accompanying drawings in which like reference numerals refer to like parts and in which:

FIG. 1 is a perspective view illustration of a base mount with an interlocking opening and peripheral mount housings, according to an embodiment of the invention;

FIG. 2 is a perspective view illustration of a camera mount adapter which fits into the interlocking opening, according to an embodiment of the invention;

FIG. 3A is a perspective view illustration of a top portion of a hook adapter for the interlocking opening, according to an embodiment of the invention;

FIG. 3B is a perspective view illustration of a bottom portion of the hook adapter for the interlocking opening, according to an embodiment of the invention;

FIG. 4 is a perspective view illustration of a secure cover adapter for the interlocking opening, according to an embodiment of the invention;

FIG. 5 is a perspective view illustration of a key for inserting and removing the secure cover, according to an embodiment of the invention;

FIG. 6 is a perspective view illustration of a cap to secure one or more magnets within the peripheral mount housings, according to an embodiment of the invention;

FIG. 7 is a perspective view illustration of a board insert with interlocking opening for inserting into the body of a sports board, according to an embodiment of the invention;

FIG. 8A is a top perspective view and bottom perspective view illustration of an extended base mount, according to an embodiment of the invention;

FIG. 8B is a bottom view illustration of an underside of the extended base mount, according to an embodiment of the invention;

FIG. 9 is a front perspective view illustration of a shelf accessory which attaches with the underside of the extended base mount, according to an embodiment of the invention;

FIG. 10 is a front perspective view image of the shelf accessory in an attached position with the extended base mount while the extended base mount is attached with a flat surface, according to an embodiment of the invention;

FIG. 11 is a side view illustration of a handle accessory which attaches with the underside of the extended base mount, according to an embodiment of the invention;

FIG. 12 is a perspective view image of the handle accessory in an attached position with the extended base mount while the extended base mount is attached with a sports board, according to one embodiment of the invention; and

FIG. 13 is a flow diagram illustrating an example process for utilizing the board mount system with a sports board in connection with various embodiments described herein.

### DETAILED DESCRIPTION

Certain embodiments disclosed herein provide for a board mount system with a base mount secured with a sports board and an interlocking opening disposed on the base mount for removably attaching interchangeable adapters that permit the connections of multiple types of accessories and tools, such as a camera, gimbal, storage hook or mount cover. The base mount may be secured physically or magnetically to the board via screws or magnets positioned at four corners of the base mount within cylindrical housings which interface directly with a surface of the board, while a mount surface of the base mount is connected with a top portion of the cylindrical housings so that the mount surface is raised above the surface of the board to allow the adapters to securely fit into the interlocking opening. The adapters can attach any type of accessory or tool with the interlocking board mount via a twist locking mechanism which does not require the use of tools and may include the tool as part of the adapter itself.

The board mount system provides a simple method to securely attach and remove any type of action sports accessory to a sports board such as a skateboard, surfboard, snowboard, paddleboard, etc., without the need for special tools or one-time use adhesive mounts. The board mount has a low profile to avoid impeding the user during use of the sport board, and it is configured to be mounted to a board deck via existing mounting screws on the board, an embedded insert within the board or a removable magnetic mount that magnetically attaches with a skateboard truck through a board deck.

The board mount system can also be utilized to attach tools such as a hook, strap or other device to secure the board to a wall, vehicle or bicycle when not in use. The tools, cameras and other sports accessories may be integrated with the interchangeable adapters or separately attached to specialized or universal mounts. Additionally, a cover may be configured to be securely attached to the interlocking opening when the mount is not in use.

After reading this description it will become apparent to one skilled in the art how to implement the invention in various alternative embodiments and alternative applications. However, although various embodiments of the present invention will be described herein, it is understood that these embodiments are presented by way of example only, and not limitation. As such, this detailed description of various alternative embodiments should not be construed to limit the scope or breadth of the present invention as set forth in the appended claims.

Board Mount System

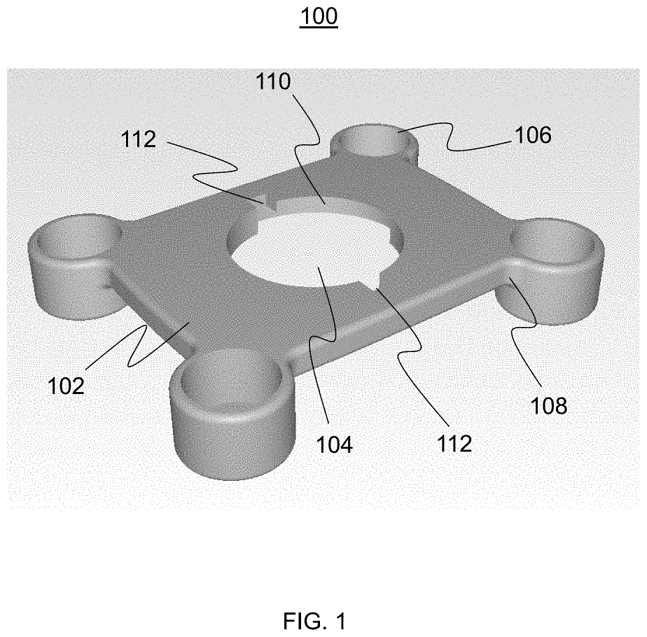

The board mount system may primarily include a base mount attached with a board deck of a sports board such as a skateboard and an interchangeable adapter which is secured within an interlocking opening on the base mount. FIG. 1 illustrates a perspective-view of one embodiment of the base mount 100, which includes a mount surface 102, an interlocking opening 104 disposed within the mount surface 102, and a set of peripheral housings 106 disposed on corners of the mount surface for retaining screws or magnets which attach the base mount 100 to the board deck. As illustrated in FIG. 1, the mount surface 102 is attached with an upper surface 108 of the peripheral housings 106 such that when the base mount 100 is secured to the board deck, the mount surface 102 is raised above the board deck to allow an adapter to fit into the interlocking opening 104.

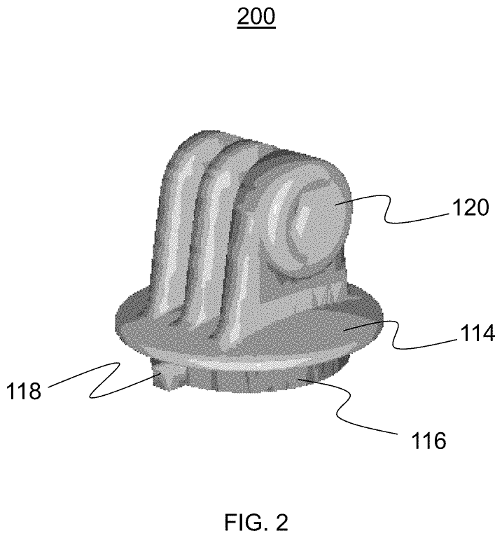

The interlocking opening 104 may be provided with a variety of options for securing an adapter, but in one embodiment, it includes a twist-lock mechanism where the interlocking opening 104 is substantially circular with a pair of grooves 110 disposed over opposing quarter sections of the edge of the opening and a pair of groove openings 112 disposed on opposing ends of the opening at one end of the grooves 110, such that a pair of tabs 118 on an adapter 200 (see FIG. 2) may be inserted into the groove openings 112 and then rotated into a locked position such that the tabs 118 are retained within the grooves 110. The adapter 200 may then be rotated back into an unlocked position to be detached from the base mount 100.

Interlocking Adapters

FIG. 2 illustrates one embodiment of an interchangeable adapter 200 which fits into the interlocking opening 104 of the base mount 100 as described immediately above. As such, the interchangeable adapter 200 may include an adapter base 114 with an interlocking connector 116 including the pair of tabs 118 which rotatably secure the adapter 200 into the interlocking opening. The adapter base 114 may be formed with one or more customized or universal connectors 120, which allow the adapter 200 to connect the mount with an accessory such as a camera, gimbal, hook, strap or other tool or device. In FIG. 2, the connector 120 is a camera attachment used to attach a small action sports camera.

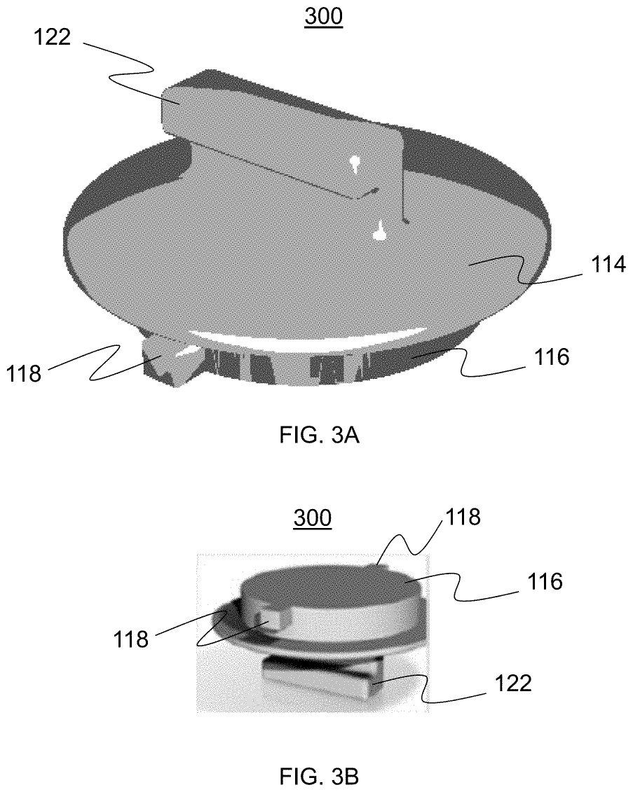

FIG. 3A illustrates an interchangeable hook adapter 300 with a hook connector 122 extending from the adapter base 114. The hook may be utilized to hang the board on a wall when the board isn't in use, or it may be configured to help secure the board to a car, bicycle or other vehicle during transport. As with the other connectors, it may be universal for use with a plurality of attachment mechanisms, or it may be proprietary and configured for attachment with a specific type of mating connector. FIG. 3B illustrates an upside-down view of the interchangeable hook adapter 300 to more clearly show the interlocking connector 116 and locking tabs 118 used to secure the hook adapter 300 to the base mount 100.

It should also be noted that the interlocking opening and corresponding connector 116 can be secured in two different opposing positions, so that the hook adapter 300 may allow the hook to face in a first or opposing second position depending on how the attached board is meant to be connected. These two positions are also useful for attaching other types of accessories such as a camera, as the user can attach the camera in the first position to have the camera facing away from the user, and in the second position to have the camera facing toward the user.

Secure Mount Cover and Key

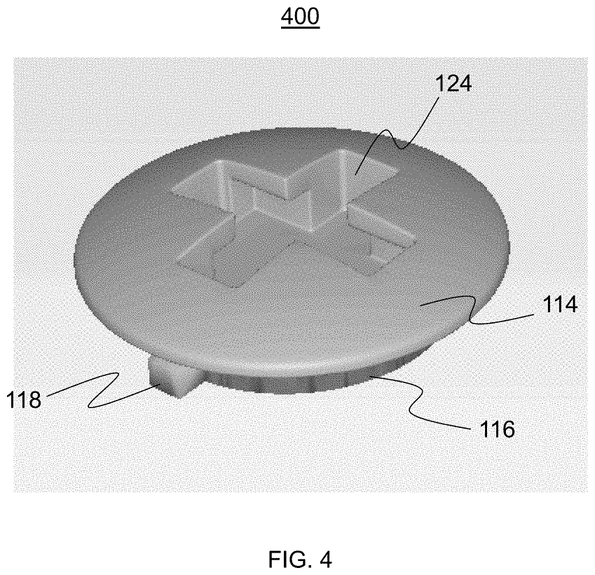

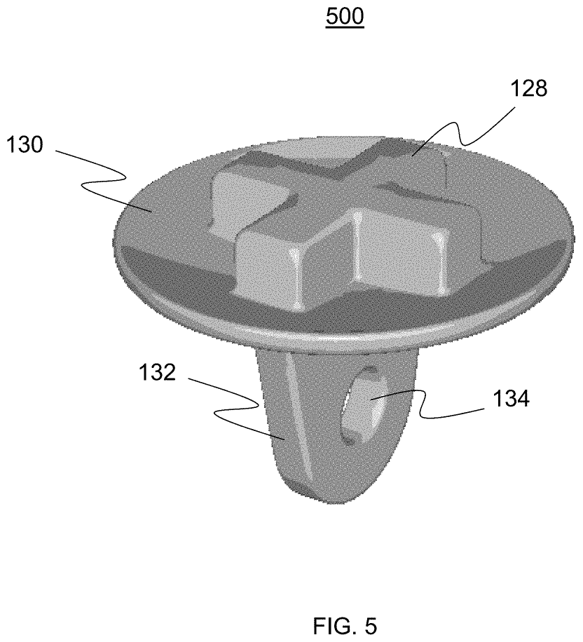

In one embodiment, a cover may be provided to cover the interlocking opening 104 when the mount system is not in use. FIG. 4 illustrates one example of the cover 400, which is similar to a standard adapter with an adapter base 114 and interlocking connector 116 with locking tabs 118, but instead of a connector 120 extending from the adapter base 114, a specially-configured slot 124 is provided in the surface of the adapter base 114 to allow the cover 400 to remain substantially flat. The slot 124 is configured to mate with a key 500, as show in FIG. 5, that contains a specially-configured tab 128 which extends from a key base 130 and which fits into the slot 124 and allows the cover 400 to be rotated from an unlocked position to a locked position. The key 500 may also include a handle 132 which allows the user to manually rotate the key from the unlocked position to the locked position, and may also include an eyelet 134 within the handle 132 to allow the user to store the key 500 on a keychain or other location.

Magnetic Mount

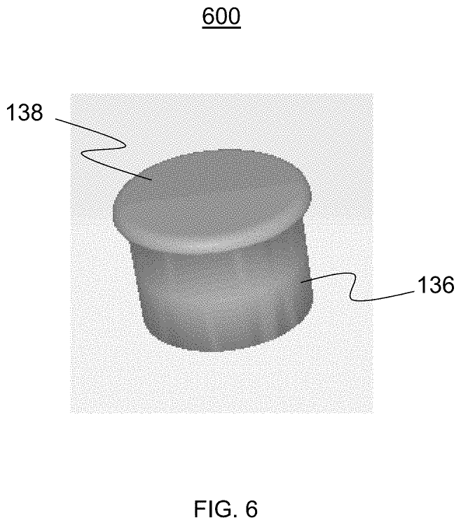

In another embodiment, the base mount 100 may be secured to the board deck via a set of magnets positioned within the peripheral housings 106 such that the magnets interact with one or more metal components of the board, such as a metal truck on a lower surface of a skateboard. Thus, instead of the peripheral housings 106 containing a screw or other permanent securing mechanism, it contains one or more magnets which securely hold the base mount 100 to the board deck during use, but which allows the base mount 100 to be easily attached and detached from the board deck without requiring tools for installation or the need for causing any damage to the board deck. In one embodiment illustrated in FIG. 6, a case 600 is provided to encase the magnets within a case housing 136, while a cap 138 covers the magnets within the peripheral housing 114 and further helps to retain the magnets within the peripheral housing 114. The case 600 also allows the magnets to be easily removed if a user wants to use the mount system with another board that cannot utilize the magnets.

Board Mount Insert

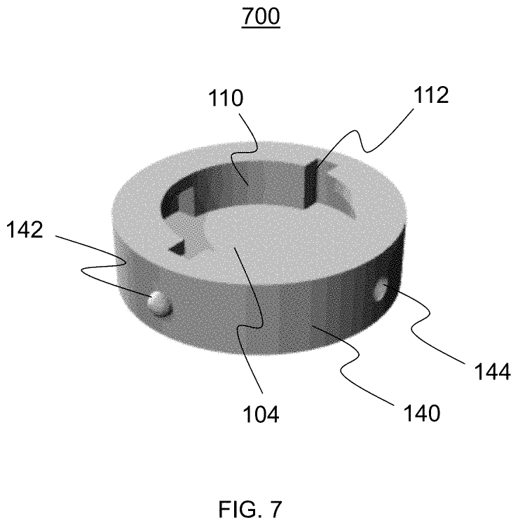

In another embodiment, it may be advantageous to place the base mount within the board deck or surface of the board, particularly where maintaining a flat surface of the board deck is preferred. In this situation, a board mount insert 700 may be provided as shown in FIG. 7. The board mount insert 700 includes the interlocking opening 104 complete with the opposing grooves 110 and groove openings 112 for rotatably attaching an adapter. However, the board mount insert 700 also includes an outer surface 140 with one or more protrusions 142 and indentations 144 for securely attaching the board mount insert 700 into a cavity in a board deck. In one embodiment, the board mount insert 700 may be cylindrical in shape in order to fit into a universal cavity provided in one or more types of sport boards that are configured for attachment of an accessory or tool.

Extended Base Mount

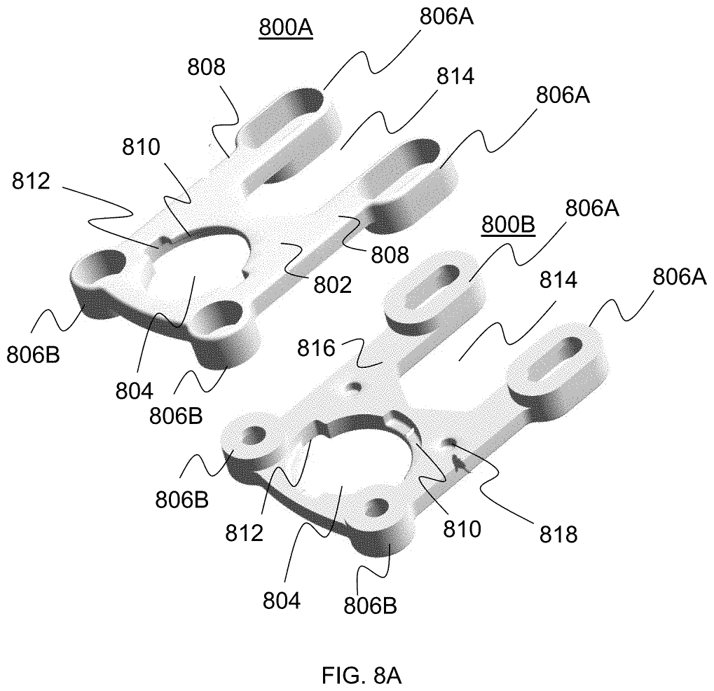

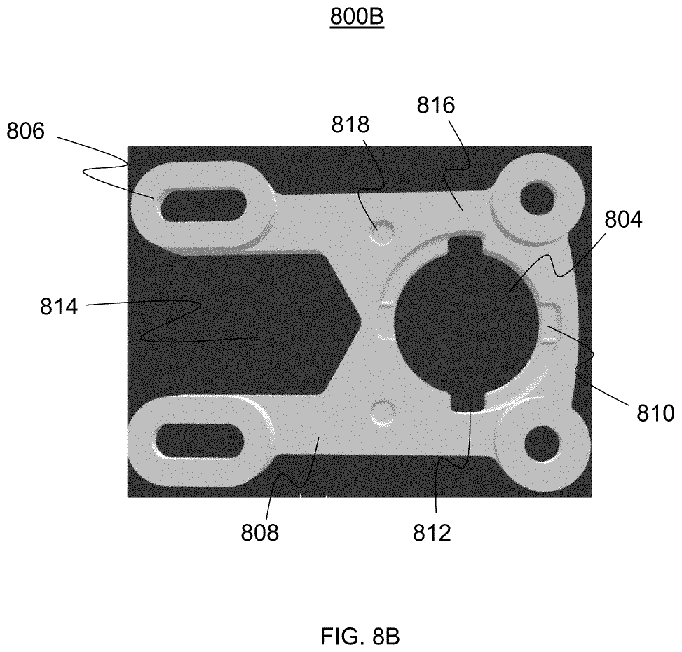

In one embodiment, an extended base mount may be provided which is configured to allow additional accessories to be attached with an underside of the base mount. FIG. 8A illustrates a top perspective view of the extended base mount 800A and a bottom perspective view of the extended base mount 800B, while FIG. 8B is a bottom view illustration of the extended base mount 800B. As with the previously described base mount 100 in FIG. 1, the extended base mount 800A includes a mount surface 802, interlocking opening 804 and peripheral housings 806 disposed at four corners of the mount 800A. The interlocking opening 804 also includes grooves 810 and groove openings 812 for securing an accessory such as the hook adapter, mount key, etc. therein.

However, the extended base mount 800 includes extension arms 808 which extend two of the peripheral housings 806A further away from the interlocking opening 104 than the opposing peripheral housings 806B, forming an insert opening 814 therebetween. The insert opening 814 is utilized to attach an additional accessory with an underside 816 of the extended mount 800 via a tongue with symmetrical tabs and dimples, as will be shown in further detail below. The tabs extend laterally from the tongue and help to secure the accessory within the insert opening 814 using the peripheral housings 806A. The tabs also include dimples which fit into dimple holes 818 in the underside 816 of the extended mount 800A to help retain the accessory. Since the mount 800 is raised above the surface of the board, the tongue can slide into the insert opening where it can be detachably attached with the board mount 800.

Underside Mount Accessories

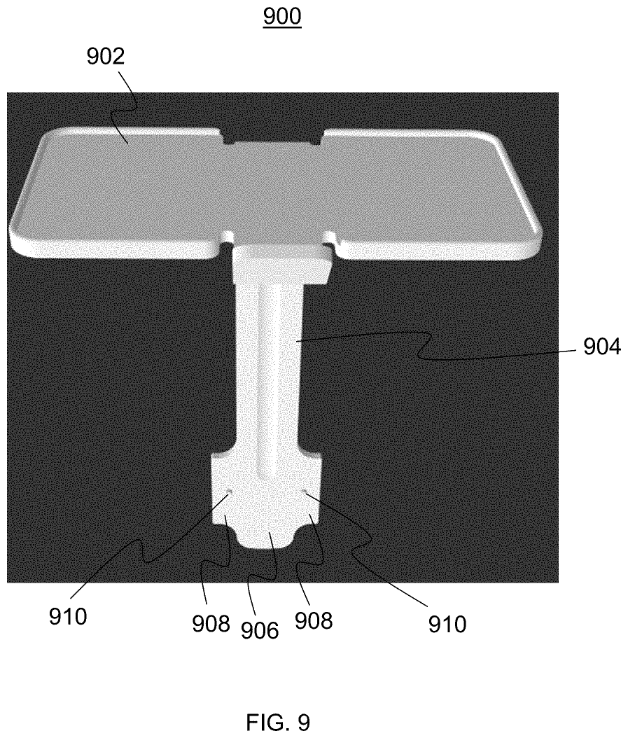

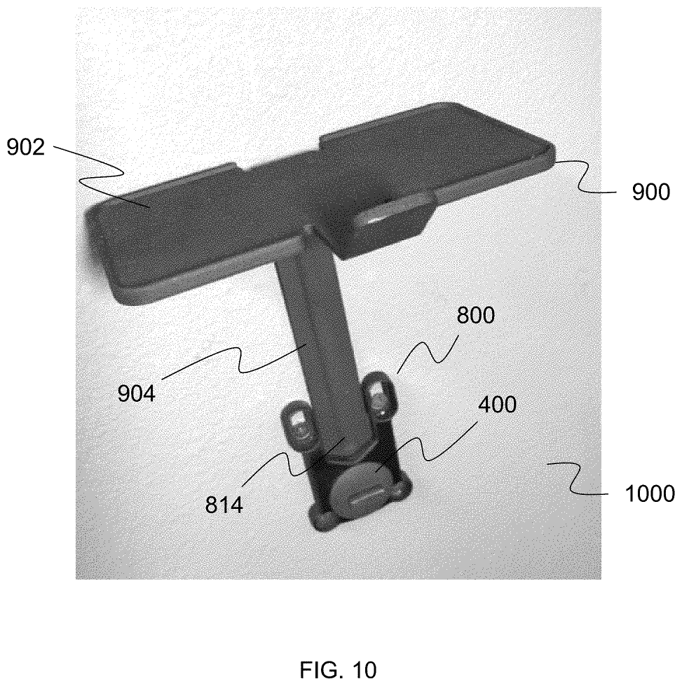

One example of an accessory which can be attached with the underside of the mount is a shelf accessory 900 which is illustrated in FIG. 9. The shelf accessory includes a shelf surface 902 for storing items when the board is not in use or if the mount is attached to a wall or other flat surface other than a board. A tongue 904 protrudes in a perpendicular direction from the shelf and has at its distal end 906 a pair of symmetrical tabs 908 extending laterally from the distal end 906, with each tab 908 having a dimple 910 which is positioned to fit into the dimple holes 818 of the underside 816 of the mount 800B. FIG. 10 illustrates the shelf 900 when it has been inserted into the insert opening 814 of the extended mount 800, where the extended mount 800 is secured to a vertical wall 1000 such that the shelf surface 902 extends perpendicularly from the wall 1000 to store any items that are placed thereon. The tongue 904 extends from the shelf surface 902 and is inserted into the extended mount 800 to secure the shelf with the mount 800. The cover 400 may also be attached with the mount 800 even while the tongue is inserted on the underside 816 of the mount, thus allowing the mount to serve multiple functions and receive multiple accessories at the same time.

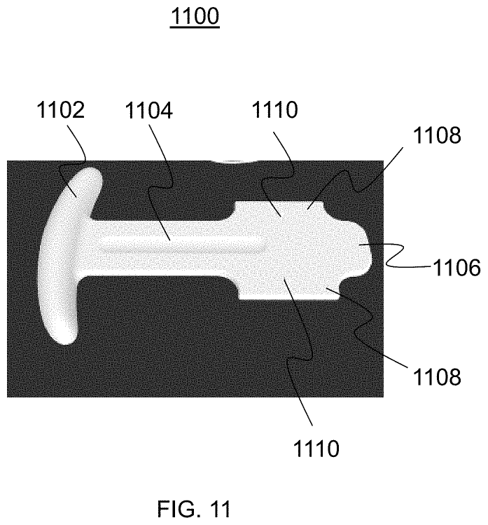

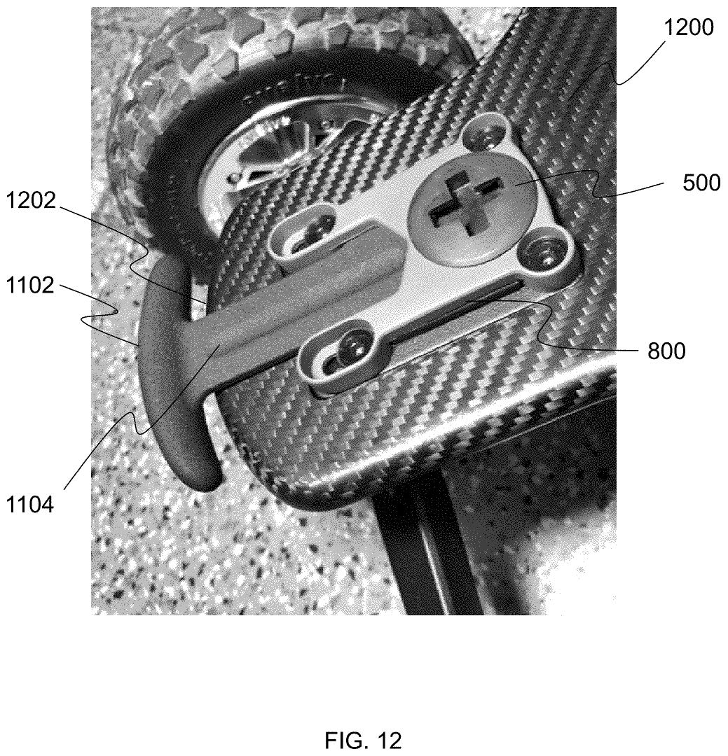

FIG. 11 illustrates a bumper and handle accessory 1100 which may be attached with the underside 816 of the extended mount 800 to protect a front portion of a sports board and also serve as a handle to carry the sports board around when it is not being used. The bumper accessory 1100 includes a bumper portion 1102 which may be a rounded cylindrical shape that is capable of absorbing an impact as a bumper and also easy for a user to hold in one hand when used as a handle. The bumper portion 1102 is attached with a tongue 1104 which extends away from the bumper portion 1102 and has a distal end 1106 identical to the distal end 906 of the shelf accessory in FIG. 9, with a pair of symmetrical tabs 1108 and dimples 1110 which retain the accessory 1100 within the underside 816 of the extended mount 800. FIG. 12 is an image illustrating the bumper and handle accessory when it has been attached with the extended mount 800 to a sports board 1200. The bumper portion 1102 extends away from the mount 800 via the tongue 1104 and extends just beyond the front 1202 of the board 1200 to protect the board from impacts. As with the shelf accessory in FIG. 10, the extended mount 800 is simultaneously capable of attaching the key 500 and the bumper accessory 1100, illustrating the dual functionality of the extended mount 800.

It will be appreciated that the underside mounting system described herein can be used to mount a multitude of different accessories to a multitude of different surfaces, with the advantages being the ability to easily attach and detach the accessories from the mount and also utilize the mount for cameras and other action sports accessories as was already described above.

Methods of Use

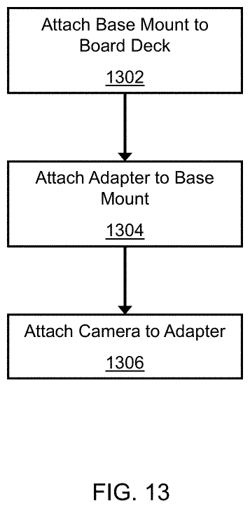

FIG. 13 illustrates one embodiment of a method of utilizing the board mount system to secure an accessory to a sports board, beginning with attaching the base mount to a board deck in step 1302. Next, in step 1304, an adapter is rotatably attached with the interlocking opening of the base mount. In step 1306, an accessory such as a camera or tool is attached with the adapter.

The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly not limited.

What is claimed is:

1. A board mount system for attaching an action sports accessory to a sport board, the system comprising:
a base mount comprising peripheral housings for attaching the base mount to a board deck of the sport board, and an interlocking opening; and
an interchangeable adapter with an interlocking connector for rotatably attaching with the interlocking opening of the base mount, and a connector for securing an action sports accessory.

2. The board mount system of claim 1, wherein the interlocking opening is a substantially circular opening with a set of opposing grooves and groove openings which receive a set of tabs on the interlocking connector that are rotated to secure the interchangeable adapter into a locked position with the base mount.

3. The board mount system of claim 1, wherein the interchangeable adapter includes an integrated hook for securing the sport board to an external object.

4. The board mount system of claim 1, wherein a surface of the adapter is substantially flat to provide a cover for the interlocking opening, and wherein the adapter includes a slot for receiving a key to rotatably secure the adapter with the interlocking opening.

5. The board mount system of claim 1, wherein the base mount is magnetically attached with the board deck via a set of magnets placed in the peripheral housings which interface with a metal portion of the sport board.

6. The board mount system of claim 1, wherein the interlocking opening is located on a mount surface of the base mount, and wherein the mount surface spaced from the surface of the board deck via the peripheral housings.

7. A method for mounting an action sports accessory to a sport board, comprising the steps of:
attaching a base mount with a board deck of the sport board;
rotatably attaching an adapter with an interlocking opening on the base mount; and
attaching an accessory with the adapter.

8. The method of claim 7, wherein the base mount is attached with the board deck via one or more magnets located in the base mount.

9. The method of claim 7, further comprising attaching an adapter with an integrated hook to the base mount in order to secure the sport board to an external object.

10. The method of claim 7, further comprising attaching an adapter cover with a substantially flat surface to the base mount to cover the interlocking opening.

11. A board mount for attaching an action sports accessory thereto, comprising:
a base mount comprising peripheral housings for attaching the base mount to a board deck of a sport board;
an interlocking opening disposed within the base mount for retaining a first accessory; and
an insert opening disposed between two of the peripheral housings on an underside of the base mount for retaining a second accessory.

12. The board mount of claim 11, further comprising a pair of dimples positioned on the underside of the base mount for further retaining the second accessory.

13. The board mount of claim 11, wherein the first accessory is a camera.

14. The board mount of claim 11, wherein the second accessory is a bumper.

15. The board mount of claim 11, wherein the second accessory includes a tongue extending from the accessory with a pair of symmetrical tabs which are attachably retained within the insert opening on the underside of the base mount.
